(19) United States
(12) Patent Application Publication
(10) Pub. No.: US 2012/0110889 A1
(43) Pub. Date: May 10, 2012

(54) FISHING ROD HOLDER

(76) Inventors: Brenda Lee DeSpiegelaere, Shoreview, MN (US); Harley G. Hughes, Shoreview, MN (US)

(21) Appl. No.: 13/233,136

(22) Filed: Sep. 15, 2011

Related U.S. Application Data
(60) Provisional application No. 61/456,278, filed on Nov. 4, 2010.

(51) Int. Cl. A01K 97/08; B23P 11/00

(52) U.S. Cl. 43/54.1; 29/428

(57) ABSTRACT

A fishing rod holder and transport device that allows a plurality of fishing rods to each be secured in place via a resistive locking channel within the rod holder. When needed the fishing rods can be quickly removed from the rod holder with a single hand and the rods are stably supported within the holders such that they will not be accidentally dislodged and will not damage the rods.

### RELATED APPLICATION INFORMATION

This application claims the benefit of U.S. Provisional Application 61/456,278, filed Nov. 4, 2010, which is hereby incorporated by reference.

### FIELD OF THE INVENTION

The present invention relates to holders for fishing rods and more particularly to portable devices for holding fishing rods during transport and/or use.

### BACKGROUND OF THE INVENTION

Most fishermen own a number of fishing poles, whether for ice fishing or fishing on open water. As such, fishermen commonly transport multiple fishing rods at a time and sometimes fish with more than one rod at a time.

A number of fishing rod holders have therefore been designed to support fishing poles either for transport of during fishing. For example, U.S. Pat. No. 3,603,019 to Smeltzer teaches attaching a fishing pole holder attached to a fishing bucket at angle to the bucket to support fishing rods during fishing. U.S. Pat. No. 5,303,500 to Luukonen depicts a bucket with an attached tray having various compartments for holding fishing gear, including slots that grasp and retain a fishing rod tip to retain the fishing rod. U.S. Pat. No. 7,594,353 to Lucky and U.S. Publ. Pat. App. No. 2005/0252071 to Urban utilize hollow tubes attached to a bucket for the purpose of supporting a fishing rod. U.S. Pat. No. 5,491,923 to Zingrone supports a fishing rod at an angle from a bucket with a cradle attached to the bucket.

There are various drawbacks to each of these designs. For example, they may not be suitable for both transport of fishing rods and supporting rods during fishing, they may cause damage to fishing rods, and they may not stably support the rod to prevent accidental dislodgement from the holder or may not allow rods to be easily inserted into the holder. As such, it would be desirable to provide a fishing rod holder that addresses these deficiencies.

### SUMMARY OF THE INVENTION

The present invention provide a fishing rod holder and transport device that allows a plurality of fishing rods to each be secured in place via a resistive locking channel within the rod holder. When needed the fishing rods can be quickly removed from the rod holder with a single hand and the rods are stably supported within the holders such that they will not be accidentally dislodged and will not damage the rods.

In one embodiment, a fishing pole holder and transport consists of a thin walled cylindrical housing, such as a bucket, to which at least one rod holder tube is fixably coupled. A channel can be cut into the thin walled tube for supporting and retaining the fishing rods. The channel can open to one end of the tube and proceed generally longitudinally towards the other end at a series of angles. The channel's pattern of angles defines an insertion path, a stop feature, and a support ledge. Insertion path allows the shank of the reel to easily slide into the channel where it rests on support ledge. Support ledge receives the shank of the reel and provides the sole support for fishing rod and reel such that no portion of the rod or rod tip is contacted. Stop feature significantly reduces the likelihood that a fishing rod will inadvertently come out of channeled thin walled tube. Thus, the channel effectively creates a locking mechanism, whereby a fishing rod can be secured in place without fear of the rod tipping over, getting stepped on, or being dragged into the water by a fish while still allowing for easy insertion. The fishing rod can be removed from the fishing rod holder by simultaneously lifting and turning the rod, thereby allowing the reel stem to pass around the stop feature in the angled channel. This action can be done with a single hand.

The above summary of the various embodiments of the invention is not intended to describe each illustrated embodiment or every implementation of the invention. This summary represents a simplified overview of certain aspects of the invention to facilitate a basic understanding of the invention and is not intended to identify key or critical elements of the invention or delineate the scope of the invention.

### BRIEF DESCRIPTION OF THE DRAWINGS

The invention may be more completely understood in consideration of the following detailed description of various embodiments of the invention in connection with the accompanying drawings, in which:

FIG. 1 depicts a perspective view of a fishing rod holder and transport and fishing rod in accordance with an embodiment of the present invention;

FIG. 2 depicts a front elevation view of a rod holder tube in accordance with an embodiment of the present invention;

FIG. 3 depicts a side elevation cross sectional view of a rod holder tube with a fishing rod in accordance with an embodiment of the present invention;

FIG. 4 depicts a front elevation view of a fishing rod holder in accordance with an embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION OF THE INVENTION

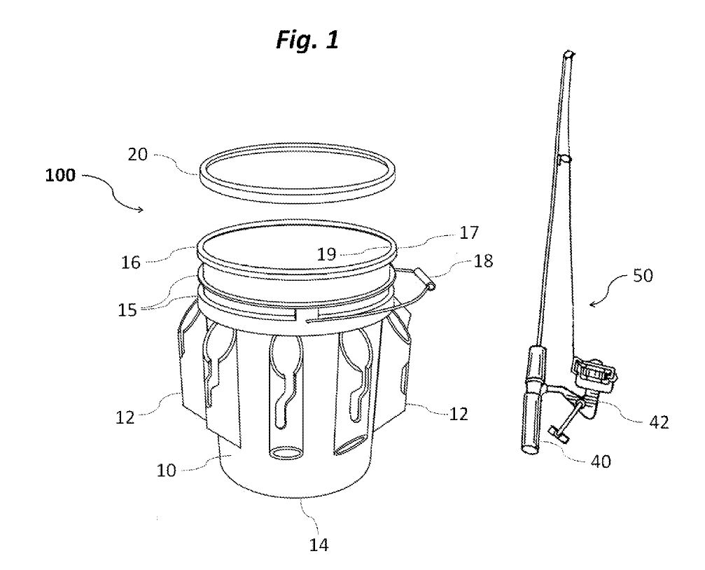

FIG. 1 depicts a fishing rod holder and transport 100 according to an embodiment of the present invention that generally includes a bucket 10 and at least one fishing rod holder tube 12. In one embodiment, bucket 10 is generally cylindrical in shape, with an upper rim 16 defining a top end of the bucket 10 and a generally sealed bottom 14. The side wall of bucket 10 is defined by an inner wall 19 and an outer wall 17 that define an open interior. One or more ridges 15 can project laterally outward from and encompass cylindrical outer wall 17 and upper rim 16 can extend laterally outward from the outer wall 17. In one embodiment, bucket 10 can have a handle 18, which can be coupled to a portion of ridge 15. The bucket 10 can also have a lid 20 which can be removably fitted on to bucket 10, to selectively seal the open interior. The size and shape of the bucket 10 is not critical to the operation of the fishing rod holder and transport 100. The description of bucket 10 provided herein has been supplied for illustrative purposes and various other sized and shaped buckets and other walled objects can be utilized with fishing rod holders as described herein.

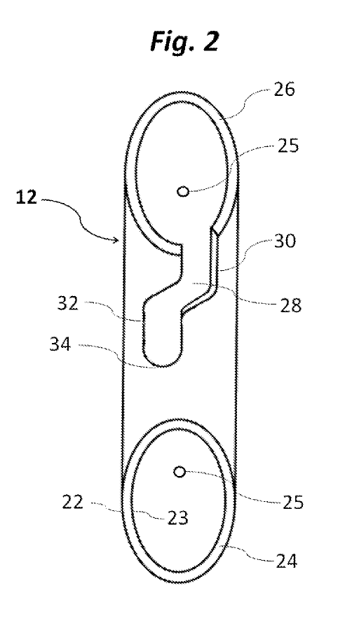

A plurality of fishing rod holder tubes 12 configured as slotted thin walled tubes can be fixably coupled to the outer wall 17 of bucket 10. A front elevation view of a rod holder tube 12 is depicted in FIG. 2. Rod holder tubes 12 can be substantially cylindrical in shape defined by an inner wall 23 and an outer wall 22. The lateral ends of rod holder tube 12 can be defined by a top 26 and a bottom 24 that can be beveled at, for example, a 45-degree angle, such that one side of slotted thin walled tube 12 is longitudinally longer than the other side of thin walled tube 12. In some embodiments, rod holder tubes 12 can be generally vertically aligned along the outer wall 17 of bucket 10 such that they are generally perpendicularly aligned with the bottom 14 and the upper rim 16 that defines the open top of the bucket.

A channel or slot 28 traverses the rod holder tube 12 in a generally longitudinal direction via a series of angles. The channel 28 extends through both inner 23 and outer 22 walls. Channel 28 opens towards the top 26 and proceeds in a defined pattern longitudinally down rod holder tube 12 towards the bottom 24. The channel 28 ends prior to reaching the beveled bottom 24. The channel 28 is defined by edges 30 and 32. Edges 30 and 32 begin at top 26 and proceed longitudinally toward bottom 24, and can proceed substantially parallel to the length of rod holder tube 12 as depicted in FIG. 2. Channel 28 then angles to either direction. In one embodiment, this angle can be offset approximately 45-degrees to either side of a line running parallel to the length of thin walled tube 12. The channel 28 can then again proceed longitudinally toward bottom 24. Although much of channel 28 is depicted in FIG. 2 as traversing along a line substantially parallel to the length of thin walled tubing 12, other non-parallel traveling patterns can also be employed. Additionally, the offset of 45-degrees between angles can be deviated from substantially.

Edges 30 and 32 of channel 28 define an insertion path 33 and meet at a bottom of channel to form a support ledge 34. Insertion path 33 allows the shank or stem of a fishing reel attached to a fishing rod to be inserted into channel with little to no interference so that it can be supported on support ledge 34. Edge 32 defines a generally downwardly facing stop feature or projection 35 configured as a ledge that provides a material interference if rod is moved vertically upwards from support ledge 34.

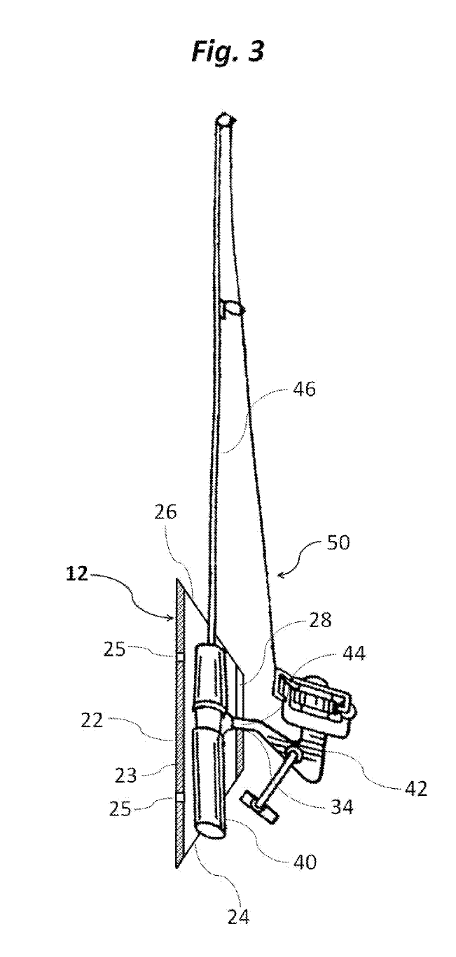

When rod holder tube 12 is viewed from in cross-section from the side, as in FIG. 3, it can be seen how channel 28 supports fishing rod 50. Fishing rod 50 consists of a rod 46, extending from a handle 40. Reel 42 connects to fishing rod 50 at handle 40 via reel stem 44. When housed in the channel 28 of fishing rod holder 12, the weight of fishing rod 50 is supported by the reel stem 44 where it rests on the support ledge 34 portion of channel 28. Rod 50 can be inserted into rod holder tube 12 by inserting rod handle 40 into the inner diameter of the rod holder tube 12 and aligned the real stem 44 with the channel 28. So that real stem 44 slides down insertion path 35 until it reaches support ledge 34. The smooth curves of insertion path 33 defined by edge 30 allow the stem to slide in with little resistance.

Fishing rod 50 can be removed from the rod holder tube 12 by lifting up on the fishing rod 50 while turning it or sliding it laterally slightly to allow the reel stem 44 to pass by the stop feature 35 along the angled path of channel 28. Because the reel stem 44 must follow the ridged path of the angled pattern in channel 28 to be released, the likelihood that fishing rod will inadvertently come out of fisher rod holder 12 is reduced. In addition, the downwardly facing stop feature 35 serves to prevent the rod from being dislodged due to vertical movement because it will block pure upward movement of the reel stem 44 beyond stop feature 35. Thus, the channel 28 effectively creates a locking mechanism, whereby fishing rod 50 can be secured in place in fishing rod holder 100 without fear of the rod 50 tipping over or falling out, getting stepped on, or being dragged into the water by a fish. However, as described above, channel 28 also provides for easy insertion of rod 50. In addition, rod 50 is supported purely by the stem 44 of the reel 42 resting on the support ledge 34, and therefore no portion of the rod or rod tip is restrained, eliminating the possibility of damage to the fragile rod that is present in fishing holders that engage the rod body and/or rod tip.

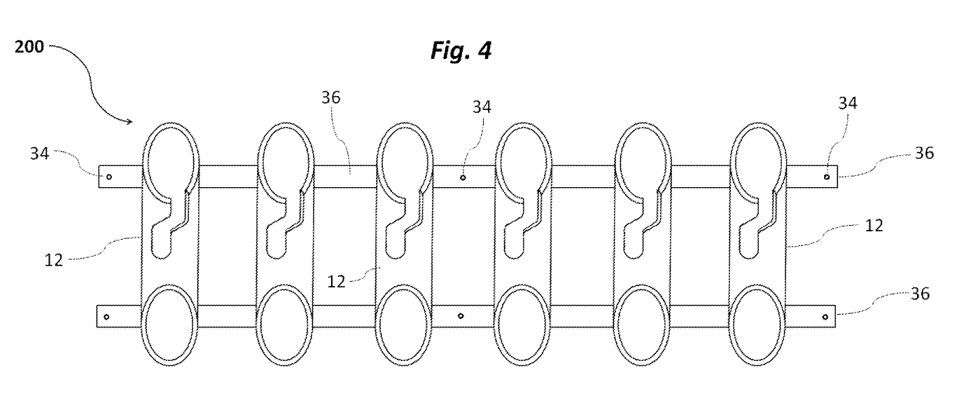

FIG. 4 depicts a fishing rod holder 200 according to another embodiment of the present invention. Rod holder 200 includes a plurality of rod holder tubes 12 are employed. However, instead of being fixably coupled to a bucket, embodiment 200 depicts the rod holder tubes 12 fixably coupled to two flexible strips 36, which can be later mounted to a wall or other surface. Several holes 34 are drilled into strips 36 to allow the fishing rod holder 200 to be easily attached to a variety of surfaces. The holes 34 can by spaced 18 inches apart to align with standard wall stud spacing. In other embodiments, strips 36 strips can utilize an adhesive or Velcro to attach to surfaces. Flexible strips can be adjusted to fit nearly any surface and any number of strips can be used as necessary. Some possibilities include, for example, a wall, an inner or outer surface of a boat, a bucket, a dock or a metal rod. Rod holder 200 can also be attached to these or other surfaces, such as the gunnel of a boat or a dock, to support one or more rods while being used during fishing.

In one embodiment, rod holder tubes 12 can be made from 1.5 inch PVC piping. In another embodiment, rod holder tubes 12 can be stamped out of sheet metal and bent into a cylindrical shape. Ends 24 and 26 can be cut at 45-degree angles. Cuts can be aligned so that the beveled ends 24 and 26 of the thin walled tube 12 angle towards one another, thereby forming a shorter and longer side when measured longitudinally. In one embodiment, the back of thin walled tube can be approximately 6 inches in height. Channel 28 can be cut into the front of the tube 12 and in one embodiment can be approximately 0.625 inches in width. Channel can be cut to approximate the above description, ending at support ledge 34 approximately 1 inch from end 24. In one embodiment, the angled portion of the channel 28 can extend for approximately ¾ inch. One or more holes 25 can be drilled into the back of tubes 12 for mounting purposes. Holes 25 should be large enough to allow standard sized fasteners to easily pass through them. Although rod holders 12 are described herein as having a generally cylindrical shape, it should be noted that any other generally enclosed shape will suffice, such as, for example, square or rectangular.

A bucket 10 can be prepped for attaching the rod holder tubes 12 by drilling a series of holes aligning with holes 25. Strips 36 can also be prepped with holes in a similar manner. The rod holder tubes 12 can then be attached via nuts and bolts or screws or other fasteners to a bucket 10 or strips 36. In other embodiments, rod holder tubes 12 can attach to bucket, strips, or other surfaces via an adhesive, a hook inserted into an opening, Velcro, or any other attachment method. Rod holder tubes 12 can also be individually attached to structures.

Various embodiments of systems, devices and methods have been described herein. These embodiments are given only by way of example and are not intended to limit the scope of the present invention. It should be appreciated, moreover, that the various features of the embodiments that have been described may be combined in various ways to produce numerous additional embodiments. Moreover, while various materials, dimensions, shapes, installation locations, etc. have been described for use with disclosed embodiments, others besides those disclosed may be utilized without exceeding the scope of the invention.

1. A fishing rod and reel holder and transport device, the fishing rod and reel including a fishing rod with an attached reel, comprising:
a housing having a top end, a bottom wall spaced from the top end and a side wall extending between the top end and the bottom wall defining an exterior surface of the housing; and
at least one hollow rod holder tube disposed on the exterior surface of the housing, the rod holder tube having an open top surface and a bottom surface with a wall extending therebetween and a channel extending through the wall from the open top surface towards the bottom surface, the channel adapted to receive a stem portion of a fishing reel therein, wherein the channel is defined by a first edge and a second edge defining an insertion path for the reel stem, the first edge and second edge meeting to form a support ledge adapted to support the fishing rod and reel by the reel stem and wherein the first edge defines a generally downwardly facing stop ledge adapted to inhibit upward vertical movement of the reel stem within the channel when the reel stem is being supported on the support ledge.

2. The fishing rod and reel holder and transport device of claim 1, wherein no portion of the device contacts the fishing rod when the fishing rod and reel are supported within the channel.

3. The fishing rod and reel holder and transport device of claim 1, wherein there are a plurality of hollow rod holder tubes disposed around the exterior surface of the housing.

4. The fishing rod and reel holder and transport device of claim 1, wherein each edge includes a first generally vertical portion extending generally vertically downward from the open top, an angled portion extending at an angle from the first generally vertical portion and second generally vertical portion extending generally vertically downward from the angled portion.

5. The fishing rod and reel holder and transport device of claim 4, wherein the angled portion of the first edge defines the stop ledge.

6. The fishing rod and reel holder and transport device of claim 4, wherein the first edge and second edge meet generally adjacent the respective second generally vertical portions to form the support ledge.

7. The fishing rod and reel holder and transport device of claim 1, wherein the housing is a bucket having an open interior.

8. The fishing rod and reel holder and transport device of claim 1, further comprising fasteners connecting the at least one hollow rod holder tube to the housing.

9. A fishing rod and reel holder, comprising:
a hollow rod holder tube having an open top surface and a bottom surface with a wall extending therebetween and a channel extending through the wall from the open top surface towards the bottom surface, the channel adapted to receive a stem portion of a fishing reel therein, wherein the channel is defined by a first edge and a second edge defining an insertion path for the reel stem, the first edge and second edge meeting to form a support ledge adapted to support the fishing rod and reel by the reel stem and wherein the first edge defines a generally downwardly facing stop ledge adapted to inhibit upward vertical movement of the reel stem within the channel when the reel stem is being supported on the support ledge.

10. The fishing rod and reel holder of claim 9, wherein no portion of the holder contacts the fishing rod when the fishing rod and reel are supported within the channel.

11. The fishing rod and reel holder of claim 9, wherein each edge includes a first generally vertical portion extending generally vertically downward from the open top, an angled portion extending at an angle from the first generally vertical portion and second generally vertical portion extending generally vertically downward from the angled portion.

12. The fishing rod and reel holder of claim 11, wherein the angled portion of the first edge defines the stop ledge.

13. The fishing rod and reel holder of claim 11, wherein the first edge and second edge meet generally adjacent the respective second generally vertical portions to form the support ledge.

14. The fishing rod and reel holder of claim 9, further comprising at least one aperture through the tube adapted to receive a fastener.

15. A method of making a fish rod and reel holder, comprising:
forming a hollow tube having an open top surface and a bottom surface with a wall extending therebetween; and
forming a channel through the wall from the open top surface towards the bottom surface, the channel adapted to receive a stem portion of a fishing reel therein, wherein the channel is defined by a first edge and a second edge defining an insertion path for the reel stem, the first edge and second edge meeting to form a support ledge adapted to support the fishing rod and reel by the reel stem and wherein the first edge defines a generally downwardly facing stop ledge adapted to inhibit upward vertical movement of the reel stem within the channel when the reel stem is being supported on the support ledge.

16. The method of claim 15, further comprising attaching the hollow tube to an exterior surface of a housing having a top end, a bottom wall spaced from the top end and a side wall extending between said top end and said bottom wall defining the exterior surface of the housing.

17. The method of claim 15, further comprising attaching the hollow tube to a flexible strip of material.

18. The method of claim 15, wherein the step of forming the channel includes forming the channel such that each edge includes a first generally vertical portion extending generally vertically downward from the open top, an angled portion extending at an angle from the first generally vertical portion and second generally vertical portion extending generally vertically downward from the angled portion.

19. The method of claim 18, wherein the angled portion of the first edge defines the stop ledge.

20. The method of claim 18, wherein the first edge and second edge meet generally adjacent the respective second generally vertical portions to form the support ledge.
